(19) United States
(12) Patent Application Publication
(10) Pub. No.: US 2013/0094676 A1
(43) Pub. Date: Apr. 18, 2013

(54) Electret Condenser Microphone

(71) Applicant: Hosiden Corporation, Osaka (JP)

(72) Inventors: Tetsuji Muraoka, Fukuoka (JP); Hidenori Motonaga, Fukuoka (JP); Kensuke Nakanishi, Fukuoka (JP)

(73) Assignee: Hosiden Corporation, Osaka (JP)

(21) Appl. No.: 13/648,269

(22) Filed: Oct. 9, 2012

(30) Foreign Application Priority Data
Oct. 18, 2011 (JP) 2011-228948

(51) Int. Cl. H04R 19/01

(52) U.S. Cl. CPC H04R 19/016
USPC 381/174

(57) ABSTRACT

An electret condenser microphoneelectret condenser microphone includes a capsule, diaphragm ring with attached diaphragm, back electrode plate having an electret-dielectric-film-coated surface facing the diaphragm, insulating spacer with space between the back electrode plate and the diaphragm, impedance converter, flexible printed circuit board in which a hollow cylinder, a flange projecting radially from an edge of the hollow cylinder on one end face facing the back electrode plate, and a rear plate blocking the other end face of the hollow cylinder are integrally formed, in which the impedance converter is placed on a surface of the rear plate facing the back electrode plate, and gate ring electrically connecting the back electrode plate to wiring on the flexible printed circuit board. An edge on an open side of the capsule bends inwardly to fit against the flange of the flexible printed circuit board.

### TECHNICAL FIELD

The present invention relates to an electret condenser microphone built into, for example, a mobile phone, video camera, etc.

### BACKGROUND ART

FIG. 1 shows the structure of a conventional electret condenser microphone (referred to below as an ECM) 8. A capsule 81 is made of metal material. A hollow cylinder 811 and a front plate 812 that blocks one end face of the hollow cylinder 811 are integrally formed. A plurality of sound holes 813 are formed in the front plate 812. Sound is introduced into the capsule 81 through the plurality of sound holes 813.

A diaphragm ring 86, made of conductive material, has one surface in contact with an inner surface of the front plate 812 and the other surface to which a diaphragm 861 is attached. The diaphragm 861, made of a conductive film, vibrates depending on the sound pressure.

An insulating spacer 85, made of insulating material, is annularly formed and keeps the space between a back electrode plate 84 and the diaphragm 861 using the thickness thereof.

The back electrode plate 84 is made of metal material. A surface of the back electrode plate 84 that faces the diaphragm 861 is coated with an electret dielectric film (not shown).

A gate ring 83, made of metal material, is cylindrically formed. One end face of the gate ring 83 is blocked by the back electrode plate 84 and the other end face is blocked by a printed circuit board 82. The gate ring 83, the back electrode plate 84, and the printed circuit board 82 form a back cabin 831.

A plurality of back holes 841 are formed in the back electrode plate 84. The plurality of back holes 841 lead a cavity between the diaphragm 861 and the back electrode plate 84 to the back cabin 831. Such a structure allows the diaphragm 861 to vibrate freely.

The printed circuit board 82 is a glass epoxy board. An impedance converter that performs impedance conversion of an electric signal generated on the back electrode plate 84 and extracts the converted signal is mounted on a surface of the printed circuit board 82 that faces the back cabin 831. The impedance converter includes a field effect transistor (referred to below as a FET) 87 and two capacitors 88. The back electrode plate 84 is electrically connected to a gate of the FET 87 through wiring on the printed circuit board 82 and the gate ring 83 and the diaphragm 861 is electrically connected to a common potential point (capsule 81) through diaphragm ring 86.

The diaphragm ring 86, the insulating spacer 85, the back electrode plate 84, the gate ring 83, and the printed circuit board 82 are laminated and housed in the capsule 81. An edge 814 on the open side is bent inward to fit against a rim of the printed circuit board 82.

The ECMs described in, for example, Japanese Patent Application Laid Open No. 2001-95097 (referred to below as patent literature 1) and Japanese Patent Application Laid Open No. 2004-349927 (referred to below as patent literature 2) are known as the prior art.

### SUMMARY OF THE INVENTION

With reduction in the size of built-in units, there is a need for reduction in size and thickness (low profile) of an ECM.

In an ECM 9 described in patent literature 1, reduction in size etc. is achieved by use of the structure shown below. FIG. 2 schematically shows reduction in size etc. of the ECM 9. For ease of explanation, only a first printed circuit board 921, a second printed circuit board 922, a capsule 91, and a FET 97 are shown. The first printed circuit board 921 and the second printed circuit board 922, which have a thickness half the thickness of the conventional printed circuit board, are laminated to form the printed circuit board of the ECM 9. Wiring electrically connected to the FET 97 is formed on the first printed circuit board 921. A through hole 923 through which the FET 97 passes is formed in the second printed circuit board 922. The second printed circuit board 922 is laminated onto the first printed circuit board 921. The ECM 9 adopts such a structure to reduce the height thereof by the thickness t₂ (that is, half the thickness of the conventional printed circuit board) of the second printed circuit board 922, thereby achieving reduction in size etc.

In addition, the diameter of the first printed circuit board 921 is smaller than that of the second printed circuit board 922. An edge 914 on an open side of the capsule 91 is bent inward to fit against the rim of the second printed circuit board 922. The thickness t₃ of the bent part is canceled by a height difference t₁ between the first printed circuit board 921 and the second printed circuit board 922. The height difference t₁ equals the thickness of the first printed circuit board 921. The ECM 9 adopts such a structure to reduce the height thereof by the thickness t₃ of the bent part, thereby achieving reduction in size etc.

However, the capacity of the back cabin of the ECM 9 becomes smaller than that of an ECM 8 by the thickness t₂ of the second printed circuit board 922. If the capacity of the back cabin is reduced, the sensitivity or signal-to-noise ratio of the ECM may be degraded.

The present invention achieves reduction in size and thickness of the ECM providing the back cabin of a sufficient capacity.

To solve the above problems, an electret condenser microphone according to an first aspect of the present invention includes a capsule that includes a first hollow cylinder and a front plate blocking one end face of the first hollow cylinder, the capsule being made of metal material, a diaphragm ring that has one surface in contact with an inner surface of the front plate and the other surface to which a diaphragm is attached, a back electrode plate that has a surface with which an electret dielectric film is coated, the surface facing the diaphragm, the back electrode plate being made of metal material, an insulating spacer that is annularly formed and present between the back electrode plate and the diaphragm to keep a space between the back electrode plate and the diaphragm, an impedance converter that performs impedance conversion of an electric signal generated on the back electrode plate and extracts a converted signal, a flexible printed circuit board in which a second hollow cylinder, a flange that projects radially from an edge of the second hollow cylinder on one end face of the second hollow cylinder that faces the back electrode plate, and a rear plate that blocks the other end face of the second hollow cylinder are integrally formed, the impedance converter being placed on a surface of the rear plate that faces the back electrode plate, and a gate ring that is cylindrically formed, is made of metal material, is present between the back electrode plate and the flexible printed circuit board to keep a space for housing the impedance converter between the back electrode plate and the flexible printed circuit board, and electrically connects the back electrode plate to wiring on the flexible printed circuit board, in which the diaphragm ring, the insulating spacer, the back electrode plate, the gate ring, and the flexible printed circuit board are laminated and housed in the capsule and an edge on an open side of the capsule is bent inward to fit against the flange of the flexible printed circuit board.

To solve the above problems, an electret condenser microphone according to an second aspect of the present invention includes a capsule that includes a first hollow cylinder and a front plate blocking one end face of the first hollow cylinder, the capsule being made of metal material, an inner surface of the front plate being coated with an electret dielectric film, a diaphragm ring that has a surface to which a diaphragm is attached, the surface facing a inner surface of the front plate, an insulating spacer that is present between the inner surface of the front plate and the diaphragm to keep a space between the inner surface of the front plate and the diaphragm, the insulating spacer being annularly formed, an impedance converter that performs impedance conversion of an electric signal generated on the diaphragm and extracts a converted signal, a flexible printed circuit board in which a second hollow cylinder, a flange that projects radially from an edge of the second hollow cylinder on one end face of the second hollow cylinder that faces the inner surface of the front plate, and a rear plate that blocks the other end face of the second hollow cylinder are integrally formed, the impedance converter being placed on a surface of the rear plate that faces the diaphragm, and a gate ring that is cylindrically formed, is made of metal material, is present between the diaphragm and the flexible printed circuit board to keep a space for housing the impedance converter between the diaphragm and the flexible printed circuit board, and electrically connects the diaphragm to wiring on the flexible printed circuit board, in which the insulating spacer, the diaphragm ring, the gate ring, and the flexible printed circuit board are laminated and housed in the capsule and an edge on an open side of the capsule is bent inward to fit against the flange of the flexible printed circuit board.

To solve the above problems, an electret condenser microphone according to an third aspect of the present invention includes a capsule that includes a first hollow cylinder and a front plate blocking one end face of the first hollow cylinder, the capsule being made of metal material, a conductive washer that has one surface in contact with an inner surface of the front plate, the conductive washer being annularly formed, a back electrode plate that has one surface in contact with the conductive washer and the other surface with which an electret dielectric film is coated, the back electrode plate being made of metal material, a diaphragm ring that has a surface to which a diaphragm is attached, the surface facing the back electrode plate, an insulating spacer that is present between the back electrode plate and the diaphragm to keep a space between the back electrode plate and the diaphragm, the insulating spacer being annularly formed, an impedance converter that performs impedance conversion of an electric signal generated on the diaphragm and extracts a converted signal, a flexible printed circuit board in which a second hollow cylinder, a flange that projects radially from an edge of the second hollow cylinder on one end face of the second hollow cylinder that faces a inner surface of the front plate, and a rear plate that blocks the other end face of the second hollow cylinder are integrally formed, the impedance converter being placed on a surface of the rear plate that faces the diaphragm, and a gate ring that is cylindrically formed, is made of metal material, is present between the diaphragm and the flexible printed circuit board to keep a space for housing the impedance converter between the diaphragm and the flexible printed circuit board, and electrically connects the diaphragm to wiring on the flexible printed circuit board, in which the conductive washer, the back electrode plate, the insulating spacer, the diaphragm ring, the gate ring, and the flexible printed circuit board are laminated and housed in the capsule and an edge on an open side of the capsule is bent inward to fit against the flange of the flexible printed circuit board.

### EFFECTS OF THE INVENTION

In the ECM according to the present invention, a flexible printed circuit board (referred to below as an FPC board) is formed through bending so as to include a hollow cylinder, a flange, and a rear plate, an impedance converter is placed on the rear plate, and an edge of the capsule is bent inward to fit against the flange. Accordingly, the ECM according to the present invention has a back cabin of a sufficient capacity while achieving reduction in size and thickness.

### BRIEF DESCRIPTION OF THE DRAWINGS

FIG. 1 is a structural diagram showing a conventional ECM.

FIG. 2 schematically shows an ECM described in patent literature 1.

FIG. 3A is a plan view showing an ECM according to a first embodiment.

FIG. 3B is a front elevational view showing the ECM according to the first embodiment.

FIG. 3C is a bottom view showing the ECM according to the first embodiment.

FIG. 4A is a perspective view showing the ECM according to the first embodiment, seen from the top.

FIG. 4B is a perspective view showing the ECM according to the first embodiment, seen from the bottom.

FIG. 5A is an exploded perspective view showing the ECM according to the first embodiment, seen from the top.

FIG. 5B is an exploded perspective view showing the ECM according to the first embodiment, seen from the bottom.

FIG. 6 is a sectional view showing the ECM according to the first embodiment.

FIG. 7A is a plan view showing an FPC board on which an impedance converter is placed.

FIG. 7B is a plan view showing the FPC board from which the impedance converter has been removed.

FIG. 7C is a plan view showing the FPC board from which the impedance converter and a resist layer 124 have been removed.

FIG. 8 is a sectional view showing the FPC board.

FIG. 9A is a structural diagram showing an example of the ECM according to the first embodiment.

FIG. 9B a structural diagram showing another example of the ECM according to the first embodiment.

FIG. 10A is a structural diagram showing an example of the ECM described in patent literature 1.

FIG. 10B is a structural diagram showing another example of the ECM described in patent literature 1.

FIG. 11 is a connection diagram showing the structure of an electric circuit according to the first embodiment.

FIG. 12 is an exploded perspective view showing an ECM according to a modification.

FIG. 13 is an exploded perspective view showing an ECM according to a second embodiment.

FIG. 14 is a sectional view showing the ECM according to the second embodiment.

FIG. 15 is a connection diagram showing the structure of an electric circuit according to the second embodiment.

FIG. 16 is an exploded perspective view showing an ECM according to a third embodiment.

FIG. 17 is a sectional view showing the ECM according to the third embodiment.

FIG. 18 is a connection diagram showing the structure of an electric circuit according to the third embodiment.

### DETAILED DESCRIPTION OF THE EMBODIMENTS

Embodiments of the present invention will be described in detail below. Components with the same functions are denoted by the same reference numerals to omit duplicate descriptions in the drawings used for the following description.

### First Embodiment

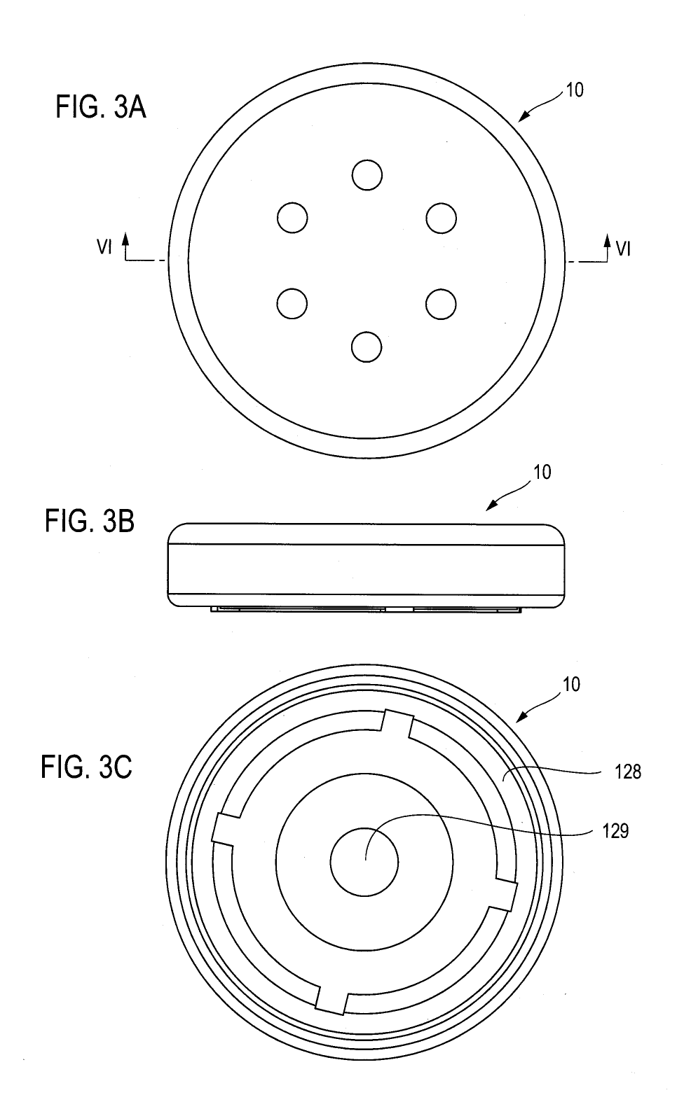

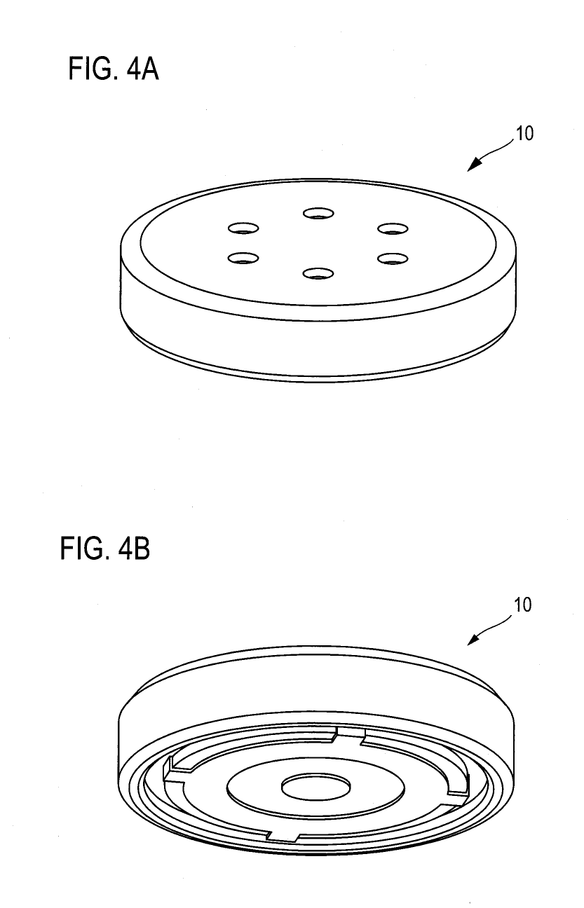

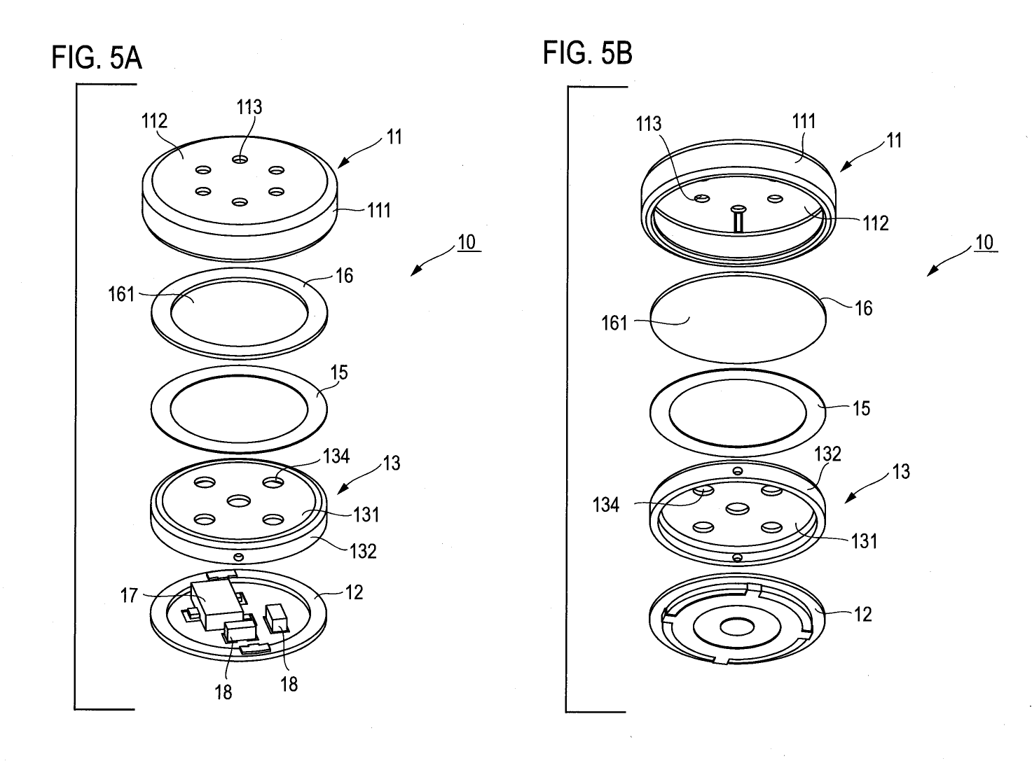

FIG. 3A is a plan view showing an ECM 10 according to a first embodiment, FIG. 3B is a front elevational view showing the ECM 10, and FIG. 3C is a bottom view showing the ECM 10. FIG. 4A is a perspective view showing the ECM 10 seen from the top and FIG. 4B is a perspective view showing the ECM 10 seen from the bottom. FIG. 5A is an exploded perspective view showing the ECM 10 seen from the top and FIG. 5B is an exploded perspective view showing the ECM 10 seen from the bottom.

The ECM 10 is a back electret condenser microphone. As shown in FIGS. 5A and 5B, the ECM 10 includes a capsule 11, an FPC board 12, a cup-shaped gate ring 13, an insulating spacer 15, and a diaphragm ring 16.

The capsule 11, made of metal material, includes a hollow cylinder 111 and a front plate 112 that blocks one end face of the hollow cylinder 111. A plurality of sound holes 113 are formed in the front plate 112.

One surface of the diaphragm ring 16 makes contact with an inner surface of the front plate 112. A diaphragm 161 is attached to the other surface of the diaphragm ring 16.

The insulating spacer 15, made of insulating material, is formed annularly.

The cup-shaped gate ring 13, made of metal material, includes a back electrode plate portion 131 and a gate ring portion 132. The back electrode plate portion 131 and the gate ring portion 132 are integrally formed.

An outer surface of the back electrode plate portion 131 and the gate ring portion 132 is coated with an electret dielectric film (not shown). Accordingly, a surface of the back electrode plate portion 131 that faces the diaphragm 161 of the back electrode plate portion 131 is coated with the electret dielectric film.

The insulating spacer 15 is present between the back electrode plate portion 131 and the diaphragm 161 and keeps the space between the back electrode plate portion 131 and the diaphragm 161 using the thickness thereof.

An impedance converter is placed on a surface of the FPC board 12 that faces the back electrode plate portion 131.

The impedance converter performs impedance conversion of an electric signal generated on the back electrode plate portion 131 and extracts a converted signal. The impedance converter includes, for example, a FET 17 and two capacitors 18. The capacitors 18 are used for measures against high frequency noise and the number of capacitors 18 is not limited to 2. Resistors may also be used in place of the capacitors. That is, it is only necessary to use at least one capacitor or resistor for measures against high frequency noise.

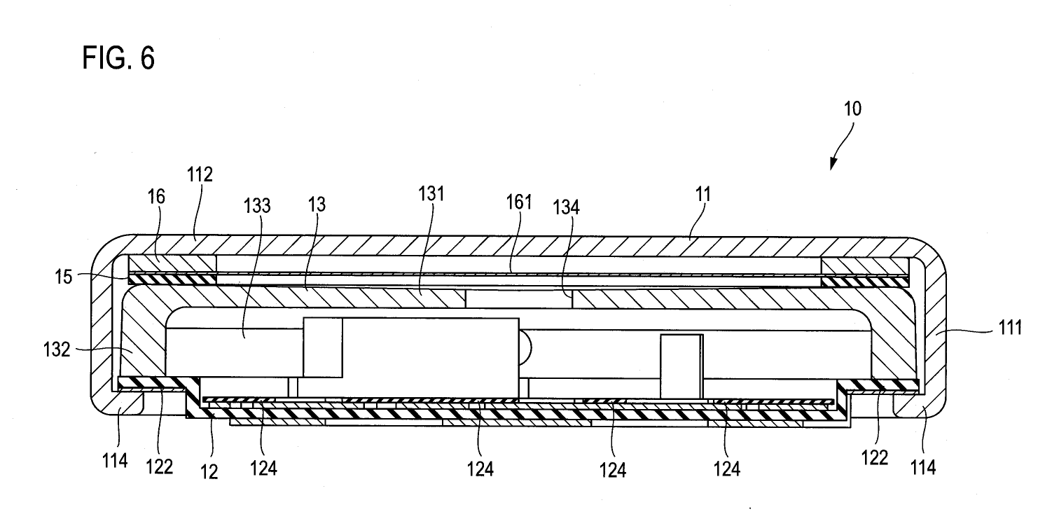

The gate ring portion 132 is cylindrically formed. As shown in FIG. 6, the gate ring portion 132 is present between the back electrode plate portion 131 and the FPC board 12 so as to keep a space for housing the impedance converter between the back electrode plate portion 131 and the FPC board 12 by the length in the axial direction of the gate ring portion 132. That is, the back electrode plate portion 131, the FPC board 12, and the gate ring portion 132 form a back cabin 133. FIG. 6 is a sectional view of a section VI-VI shown in FIG. 3A.

The back electrode plate portion 131 is electrically connected to wiring on the FPC board 12 through the gate ring portion 132. A plurality of back holes 134 are formed in the back electrode plate portion 131. The plurality of back holes 134 lead a cavity between the diaphragm 161 and the back electrode plate portion 131 to the back cabin 133. Such a structure allows the diaphragm 161 to vibrate freely. The diaphragm 161 is electrically connected to a common potential point (capsule 11) through the diaphragm ring 16.

The diaphragm ring 16, the insulating spacer 15, the cup-shaped gate ring 13, and the FPC board 12 are laminated as shown in FIG. 6 and housed in an internal space (formed by the hollow cylinder 111 and the front plate 112) of the capsule 11. An edge 114 on the open side of the capsule 11 is bent inward to fit against a flange 122, which will be described below, of the FPC board 12.

<FPC Board 12>

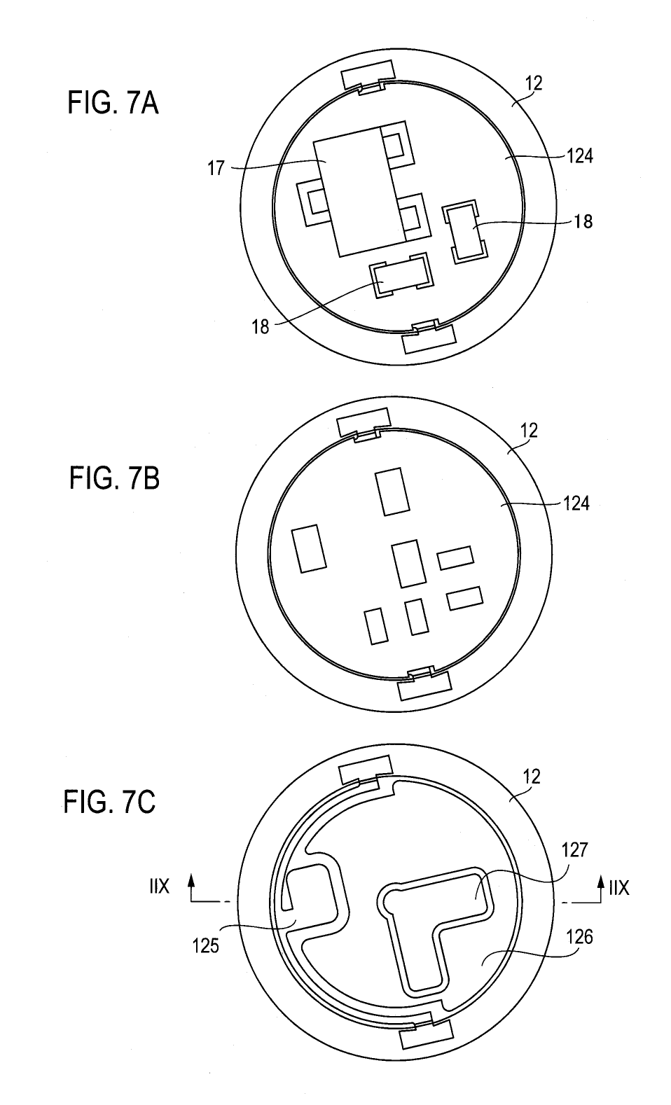

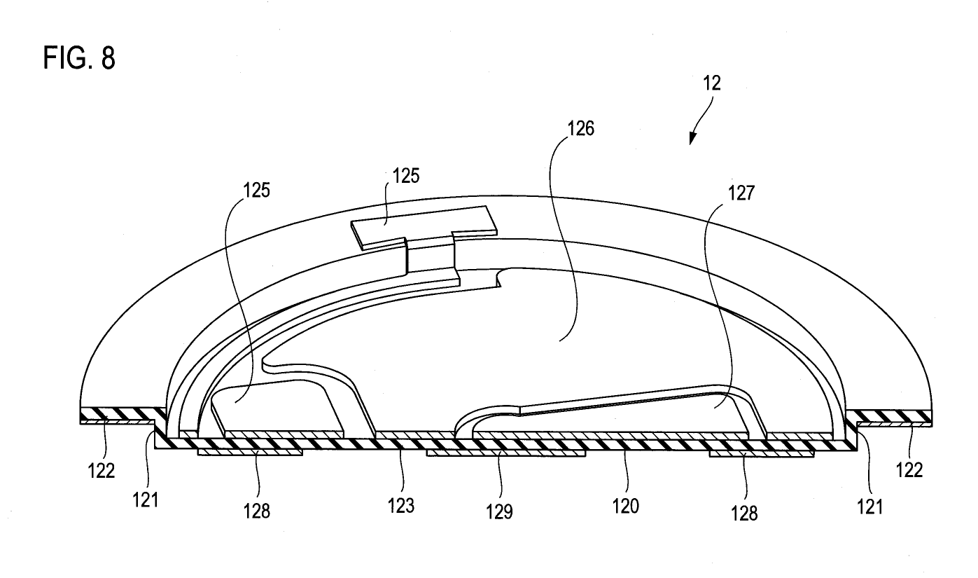

The FPC board 12 will be described in detail below. FIG. 7A is a plan view showing the FPC board 12 on which an impedance converter (including the FET 17 and the two capacitors 18) is placed. FIG. 7B is a plan view showing the FPC board 12 from which the impedance converter has been removed. FIG. 7C is a plan view showing the FPC board 12 from which the impedance converter and a resist layer 124 (see FIG. 6) have been removed. FIG. 8 is a perspective view showing a section IIX-IIX shown in FIG. 7C.

In the FPC board 12, an adhesive layer is formed on an insulating film (base film 120) and conductive thin leaves (a gate pattern 125, a first printed circuit wiring 126, a second printed circuit wiring 127, a common electrode 128, and a signal electrode 129) are formed on the adhesive layer (see FIGS. 7C, 3C, and 8). The portions other than terminals or soldered portions are covered with an insulating material (a resist layer 124) (see FIG. 7B). For example, the base film 120 and the resist layer 124 are made of polyimide film and conductive thin leaves are made of copper.

As shown in FIG. 8, the FPC board 12 includes a hollow cylinder 121, the flange 122, and a rear plate 123, which are integrally formed. The flange 122 projects radially from an edge of the hollow cylinder 121 on one end face of the hollow cylinder 121 that faces the back electrode plate portion 131. The rear plate 123 blocks the other end face of the hollow cylinder 121. The impedance converter is placed on a surface of the rear plate 123 that faces the back electrode plate portion 131 (see FIG. 5A). That is, the hollow cylinder 121 extends toward the back cabin 133 from the rim of the rear plate 123. The flange 122 is placed closer to the back electrode plate portion 131 than the rear plate 123 and projects radially from the edge of the hollow cylinder 121.

The FPC board 12 is bent so as to have the hollow cylinder 121, the flange 122, and the rear plate 123. After the bending, the impedance converter is placed on a surface of the rear plate 123 that faces the back electrode plate portion 131.

<Action and Effect>

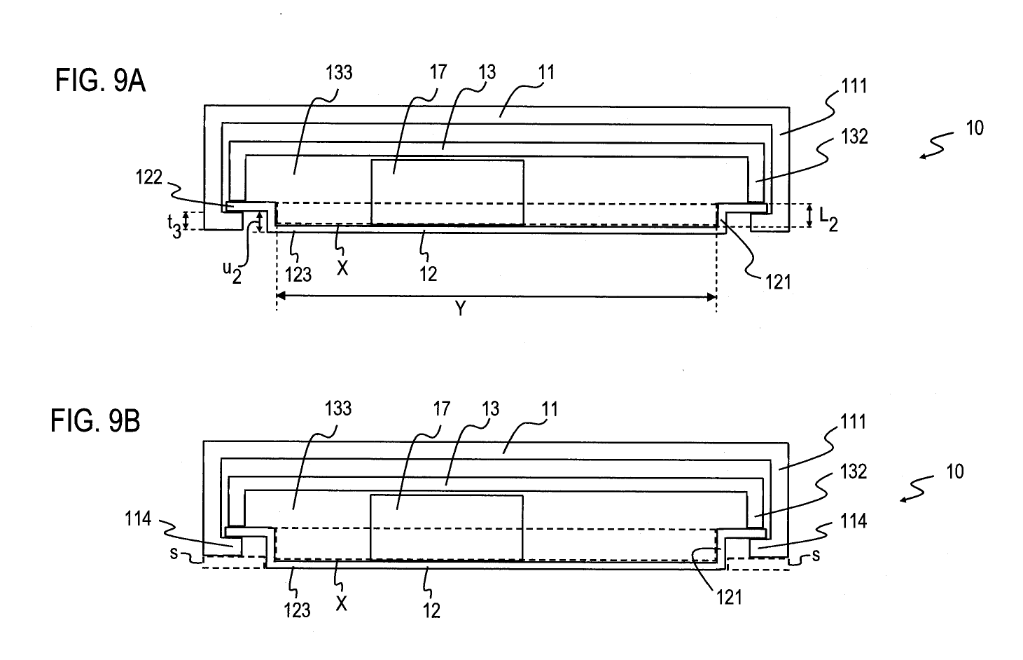

FIGS. 9A and 9B are structural diagrams showing the ECM 10. There are differences in the lengths of the hollow cylinder 121, the gate ring portion 132, and the hollow cylinder 111 between FIGS. 9A and 9B. For ease of explanation, FIGS. 9A and 9B show only the capsule 11, the cup-shaped gate ring 13, the FPC board 12, and the FET 17.

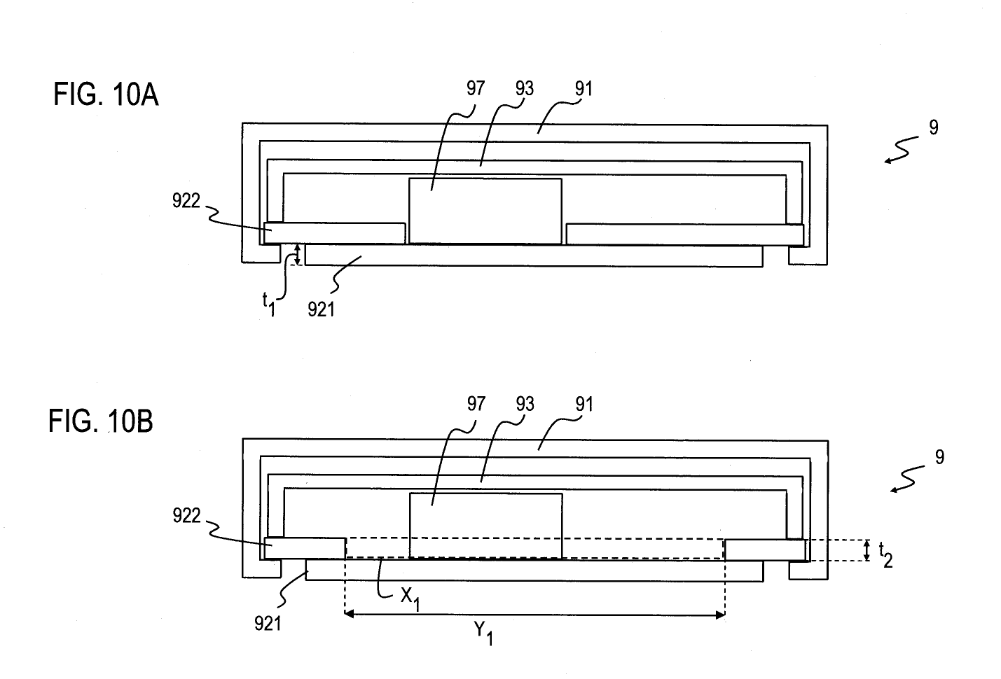

FIGS. 10A and 10B are structural diagrams showing the ECM 9 described in patent literature 1. The ECM 9 described in patent literature 1 is a front electret condenser microphone, but the ECM 9 described here is a back electret condenser microphone to which the technique described in patent literature 1 has been applied, for ease of comparison. For ease of explanation, FIGS. 10A and 10B only show a capsule 91, a cup-shaped gate ring 93, a first printed circuit board 921, a second printed circuit board 922, and a FET 97.

(Reduction in Thickness and Size)

As shown in FIG. 9A, a height difference u₂ is formed between the flange 122 and the rear plate 123. The impedance converter is placed on the rear plate 123 so that a lower part of the impedance converter is housed in a space X formed by the hollow cylinder 121 and the rear plate 123. The thickness t₃ of the bent part is canceled by the height difference u₂. The ECM 10 adopts such a structure to reduce the height thereof by the thickness t₃ of the bent part, thereby achieving reduction in size etc. Although a board with a laminated structure needs to be used to provide a height difference in patent literature 1, a single layer structure is sufficient in the first embodiment. Accordingly, when the ECM 10 according to the first embodiment is manufactured, processes such as manufacturing of printed wiring for electrically connecting boards to each other, adhesion of boards, and machining of through holes are not required, thereby improving the efficiency.

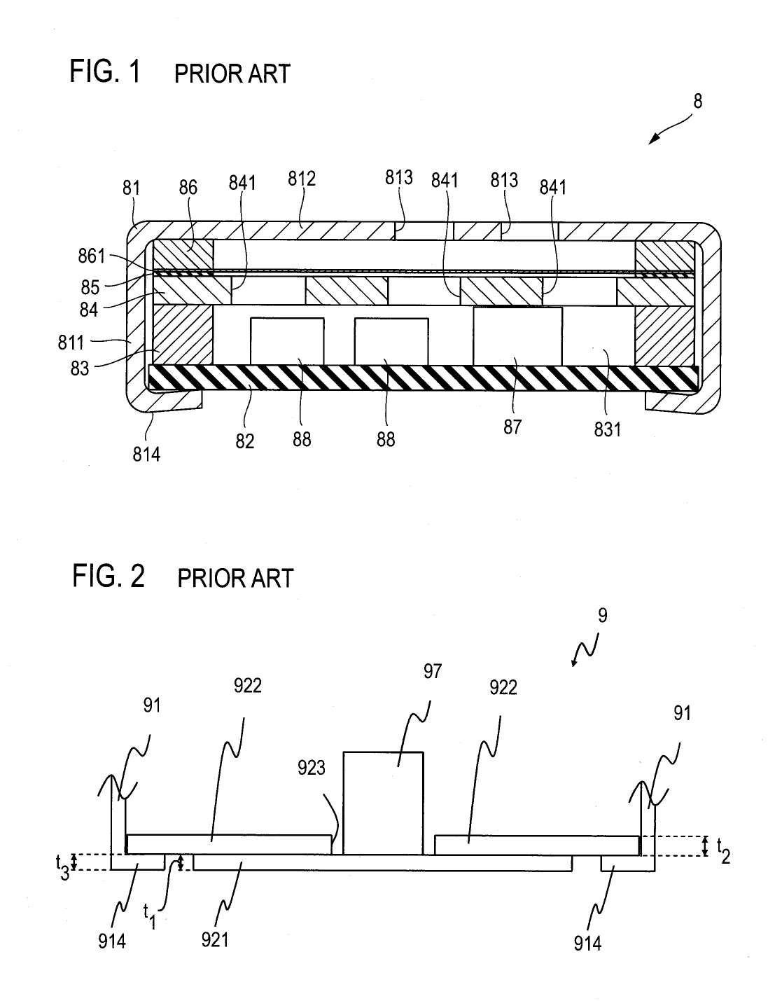

The printed circuit board 82 shown in FIG. 1, and the first printed circuit board 921 and the second printed circuit board 922 shown in FIG. 10A are rigid boards made of glass epoxy etc. Generally, a flexible board can be machined thinner than a rigid board. Therefore, the height of the ECM 10 can reduce by the thickness reduced, thereby achieving reduction in size etc.

(Installation Area and Back Cabin Capacity)

As shown in FIG. 9A, the space X formed by the hollow cylinder 121 and the rear plate 123 is a part of the back cabin 133. On the other hand, the ECM 9 has no space equivalent to the space X, as shown in FIG. 10A. Accordingly, the back cabin of the ECM 10 is larger than that of the ECM 9 by the space X. That is, the ECM 10 can keep the back cabin capacity almost the same as in the ECM 8 shown in FIG. 1 while achieving reduction in size etc.

In addition, the FPC board 12 can be freely bent into a shape that includes the hollow cylinder 121, the flange 122, and the rear plate 123, which are described above. Accordingly, it is possible to maximize an area (referred to below as an installation area) on the rear plate 123 on which the impedance converter is placed. This maximizes the space X.

On the other hand, a rigid board cannot be bent freely. Even though the second printed circuit board 922 is formed annularly as shown in FIG. 10B to increase an installation area on the first printed circuit board 921, an area for adhesion needs to be kept on the first printed circuit board 921. Accordingly, this installation area becomes smaller than that on the FPC board 12 by the area for adhesion.

The installation area on the FPC board 12 is a circular area with the diameter Y (see FIG. 9A) and the installation area on the first printed circuit board 921 is a circular area with the diameter Y₁ (see FIG. 10B). Accordingly, if the outer diameter of the FPC board 12 is equal to that of the second printed circuit board 922, the installation area on the FPC board 12 is larger than that of the second printed circuit board 922. In addition, the volume of the space X is equal to the area of the circle with the diameter Y multiplied by the length L₂ of the hollow cylinder 121, and the volume of the space X₁ is equal to the area of the circle with the diameter Y₁ multiplied by the thickness t₂ of the second printed circuit board 922. Accordingly, if the outer size of the ECM 10 is equal to that of the ECM 9, the back cabin capacity of the ECM 10 is larger than that of the ECM 9.

An increase in the installation area has an effect of increasing the degree of freedom to which the impedance converter or the like is placed. An increase in the back cabin capacity raises expectation for improving the ECM sensitivity and signal-to-noise ratio.

(Degree of Freedom of the Size of a Height Difference)

Since the FPC board 12 can be bent freely, the length of the hollow cylinder 121 or the height difference u₂ can be changed freely depending on the thickness t₃ of a bent part, the size of a desired space X, the shape of the mounting surface, or other components. On the other hand, for the ECM 9, the thickness of the first printed circuit board 921 needs to be changed in order to change the height difference t₁, so the degree of freedom is considered to be low.

For example, if the length in the axial direction of the hollow cylinder 121 of the FPC board 12 is increased and the length of the gate ring portion 132 of the cup-shaped gate ring 13 and the length of the hollow cylinder 111 of the capsule 11 are reduced as shown in FIG. 9B, the size of the ECM 10 can be reduced. A space s can be formed between the edge 114 of the capsule 11 and the mount board. A resist layer of the mount board or other components etc. may be present in the space s. Since the space X becomes large, a back cabin of almost the same capacity as in the ECM 10 shown in FIG. 9A is formed.

On the other hand, for the ECM 9, the thickness of the first printed circuit board 921 needs to be increased in order to form the space s, so the ECM 9 becomes thicker and larger.

<Circuit Diagram>

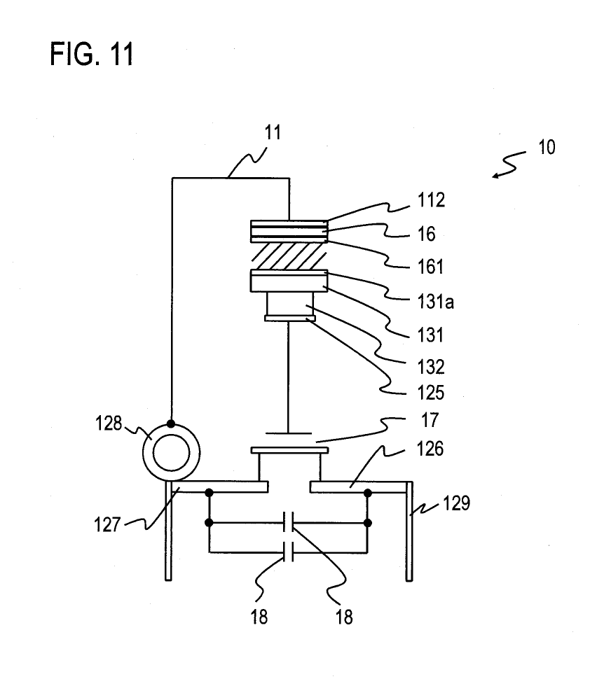

FIG. 11 shows the circuit diagram of the ECM 10. The gate pattern 125, the first printed wiring 126, and the second printed wiring 127 are placed as shown in FIG. 7C, and the common electrode 128 and the signal electrode 129 are placed as shown in FIG. 3C. The first printed wiring 126 and the signal electrode 129 are electrically connected to each other via a through hole (not shown) disposed in the FPC board 12. Similarly, the second printed wiring 127 and the common electrode 128 are electrically connected to each other.

The diaphragm ring 16, the insulating spacer 15, the cup-shaped gate ring 13, and the FPC board 12 are laminated and housed in the capsule 11. The edge 114 on the open side of the capsule 11 is bent inward to fit against the common electrode 128 on the flange 122, and the diaphragm 161 is electrically connected to the common electrode 128 through the capsule 11, the front plate 112, and the diaphragm ring 16. In addition, an electret dielectric film 131a is electrically connected to a gate electrode of a FET 17 through the back electrode plate portion 131, the gate ring portion 132, and a gate pattern 125.

As is clear from the electric circuit shown in FIG. 11, the diaphragm 161 is vibrated by a sound and static electricity charged on the electret dielectric film 131a generates an electric signal. This electric signal is subjected to impedance conversion by the FET 17 and output externally through the common electrode 128 and the signal electrode 129.

Even if the FPC board 12 shown in FIG. 6 is bowed toward the back electrode plate portion 131 due to an impact etc. and the upper surface of the FET 17 makes contact with the bottom of the back electrode plate portion 131, the contact has no effects on an electric signal to be generated, as is clear from the above circuit diagram. Accordingly, the performance of the electret condenser microphone is not affected.

<Modification>

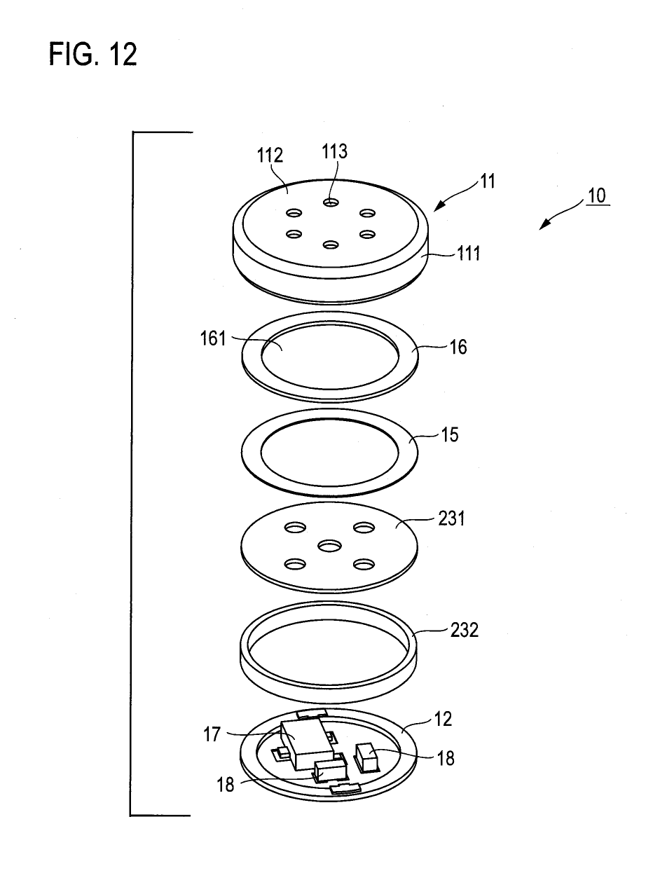

The back electrode plate portion 131 and the gate ring portion 132 are integrally formed in the first embodiment, but these portions may be separately formed as a back electrode plate 231 and a gate ring 232 (see FIG. 12). In this case, the back electrode plate 231 is made of metal material and a surface of the back electrode plate 231 that faces the diaphragm 161 is coated with an electret dielectric film (not shown). The gate ring 232, made of metal material, is cylindrically formed. The gate ring 232 is present between the back electrode plate 231 and the FPC board 12, and keeps a space for housing the impedance converter between the back electrode plate 231 and the FPC board 12. The gate ring 232 electrically connects the back electrode plate 231 to the wiring on the FPC board 12. In addition, the back electrode plate portion 131 and the insulating spacer 15 are separately formed in the first embodiment, but these parts may be integrally formed through insertion molding as described in patent literature 2. That is, the gate ring, the back electrode plate, and the insulating spacer may be separately formed or may be integrally formed.

A reinforcing plate may be laminated onto the FPC board 12. For example, a reinforcing plate may be attached to the mounting surface of the rear plate 123. Such a structure enables the FPC board 12 to be bent freely and improves the stiffness.

Before the FPC board 12 is bent, the impedance converter may be placed on a surface of the rear plate 123 that faces the back electrode plate portion 131 and, after the placement, the FPC board 12 may be formed through bending so as to include the hollow cylinder 121, the flange 122, and the rear plate 123, which are described above.

An adhesive may be applied to a surface of the flange 122 that is located on the side of the mounting surface. Bonding by this adhesive in addition to bending of the edge 114 allows the FPC board 12 to be fixed to the capsule 11 more securely. However, a process for hardening the adhesive is required during manufacturing.

The entire thickness t₃ of the bent part is not necessarily canceled by the height difference u₂ and only a part of the thickness t₃ may be canceled by the height difference u₂. In this case, the ECM 10 can be reduced in thickness and size by the canceled thickness.

The shape of the bent FPC board 12 is not limited to the first embodiment and may be any shape that allows the height difference u₂ to cancel the bent part of the edge 114. For example, the inner diameter of the flange 122 may be formed larger than the outer diameter of the rear plate 123 and the hollow cylinder 121 may be formed into a tapered shape. In addition, for example, the flange 122 radially projects in a continuous manner as a flat ring from the edge of the hollow cylinder 121 (see FIG. 5A), but the flange 122 may project in a discontinuous manner as long as the flange 122 has a shape that allows the edge 114 to be bent inward to fit thereagainst.

### Second Embodiment

### Front Electret Condenser Microphone

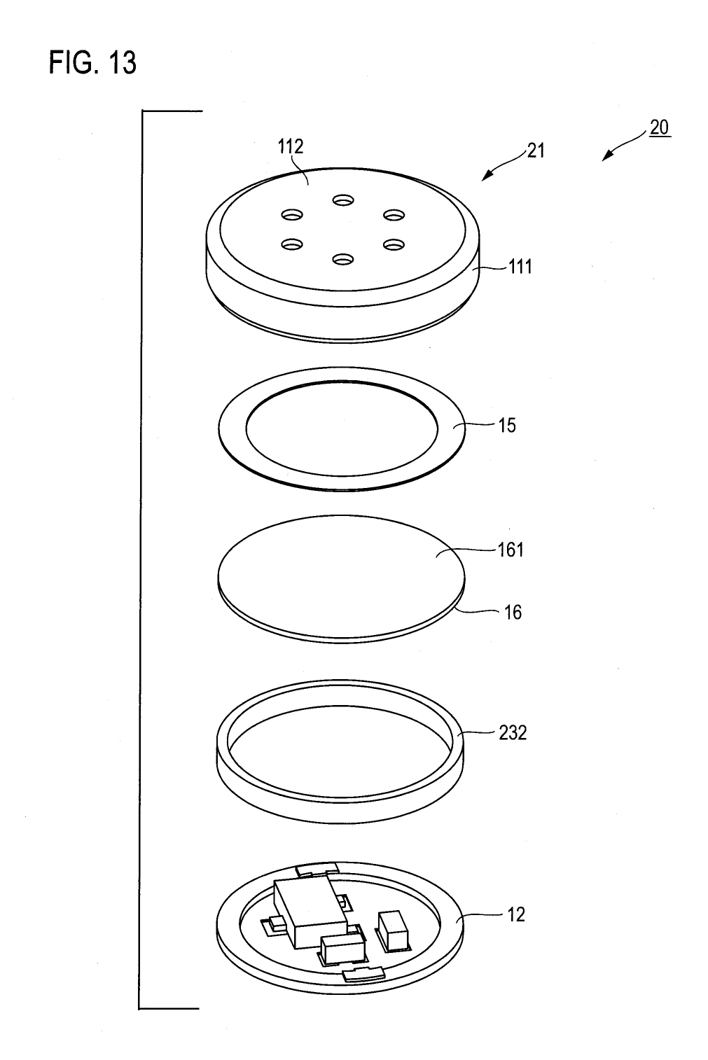

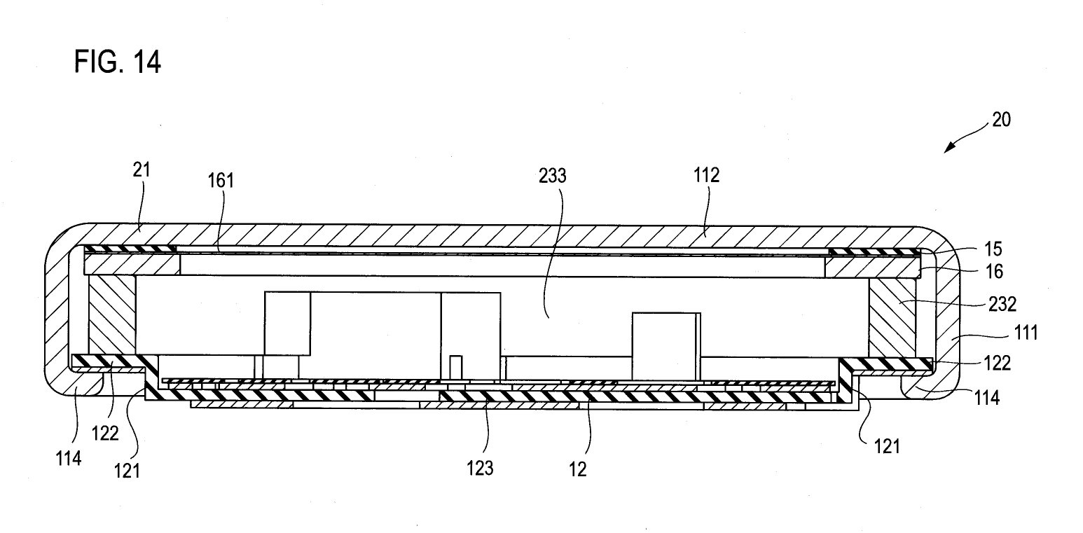

Only the difference from the first embodiment will be described below. FIG. 13 is an exploded perspective view showing an ECM 20 seen from the top and FIG. 14 is a sectional view showing the ECM 20.

The ECM 20 is a front electret condenser microphone. As shown in FIG. 13, the ECM 20 includes a capsule 21, the FPC board 12, the insulating spacer 15, the diaphragm ring 16, and the gate ring 232. In the second embodiment, the back electrode plate portion 131 and the back electrode plate 231 are not provided, and the front plate 112 of the capsule 21 is used in place of these back electrode plates.

The capsule 21, made of metal material, includes the hollow cylinder 111 and the front plate 112 that blocks one end face of the hollow cylinder 111. An inner surface of the front plate 112 is coated with an electret dielectric film (not shown). Accordingly, a surface of the front plate 112 that faces the diaphragm 161 is coated with the electret dielectric film.

The diaphragm 161 is attached to a surface of the diaphragm ring 16 that faces a inner surface of the front plate 112. The other surface makes contact with the gate ring 232.

The insulating spacer 15 is present between the inner surface of the front plate 112 and the diaphragm 161 and keeps the space between the inner surface of the front plate 112 and the diaphragm 161.

The FPC board 12 is integrally formed by a hollow cylinder 121, a flange 122 that projects radially from an edge of the hollow cylinder 121 on one end face of the hollow cylinder 121 that faces the inner surface of the front plate 112, and a rear plate 123 that blocks the other end face of the hollow cylinder 111. An impedance converter is placed on a surface of the rear plate 123 of the FPC board 12 that faces the diaphragm 161. The impedance converter performs impedance conversion of an electric signal generated on the diaphragm 161 and extracts a converted signal.

The gate ring 232 is cylindrically formed, made of metal material, and present between the diaphragm 161 and the FPC board 12 so as to keep a space for housing the impedance converter between the diaphragm 161 and the FPC board 12 by the length in the axial direction of the gate ring 232. That is, the diaphragm 161, the FPC board 12, and the gate ring 232 form a back cabin 233 as shown in FIG. 14. The diaphragm 161 is electrically connected to wiring (gate pattern 125) on the FPC board 12 through the diaphragm ring 16 and the gate ring 232.

The insulating spacer 15, the diaphragm ring 16, the gate ring 232, and the FPC board 12 are laminated and housed in the capsule 21. An edge 114 on the open side of the capsule 21 is bent inward to fit against the flange 122 of the FPC board 12.

<Circuit Diagram>

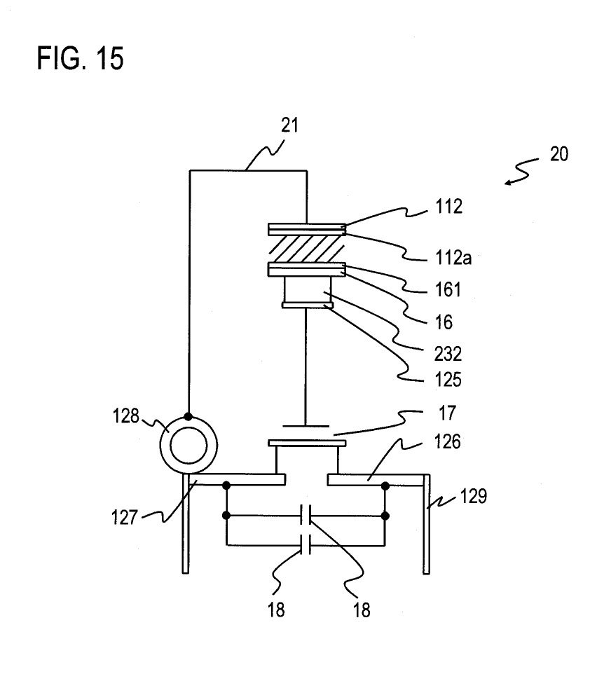

FIG. 15 shows a circuit diagram of the ECM 20. Since the edge 114 on the open side of the capsule 21 is bent inward to fit against a common electrode 128 on the flange 122, an electret dielectric film 112a is electrically connected to the common electrode 128 through the capsule 21 and the front plate 112, and the diaphragm 161 is electrically connected to a gate electrode of the FET 17 through the diaphragm ring 16, the gate ring 232, and the gate pattern 125.

As is clear from the electric circuit shown in FIG. 15, the diaphragm 161 is vibrated by a sound and static electricity charged on the electret dielectric film 131a generates an electric signal on the diaphragm 161. This electric signal is subjected to impedance conversion by the FET 17 and output externally through the common electrode 128 and the signal electrode 129.

The front electret condenser microphone with such a structure has the same effects as the first embodiment.

### Third Embodiment

### Reverse Electret Condenser Microphone

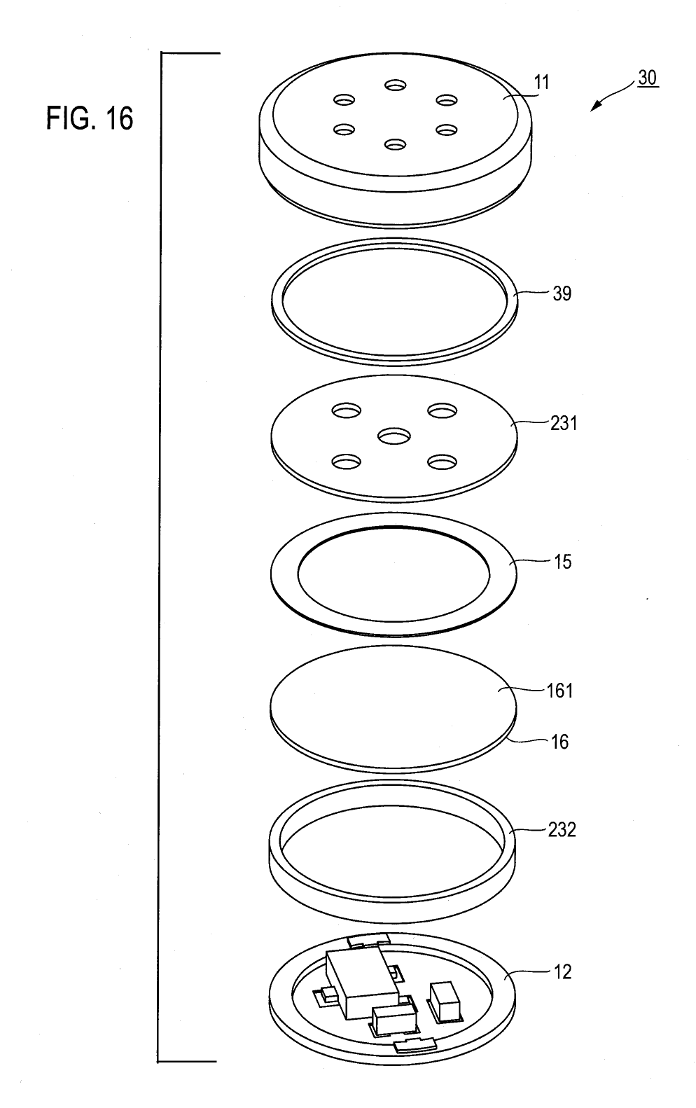

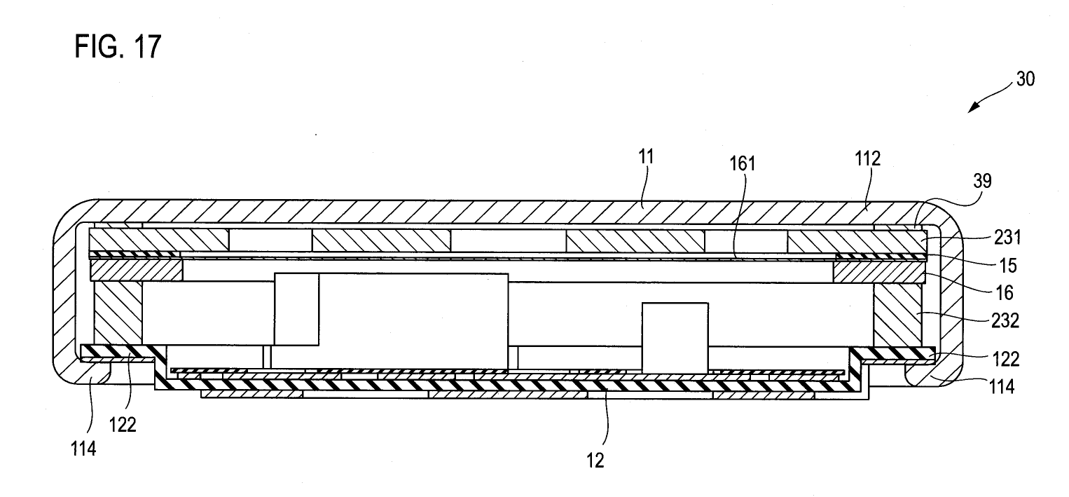

Only the difference from the second embodiment will be described below. FIG. 16 is an exploded perspective view showing an ECM 30 seen from the top and FIG. 17 is a sectional view showing the ECM 30.

The ECM 30 is a reverse electret condenser microphone. As shown in FIG. 16, the ECM 30 includes the capsule 11, the FPC board 12, a conductive washer 39, the back electrode plate 231, the insulating spacer 15, the diaphragm ring 16, and the gate ring 232. The third embodiment uses the back electrode plate 231 with the positional relation between the electret dielectric film and the diaphragm being the same as in the second embodiment.

The conductive washer 39 is annularly formed and one surface thereof makes contact with inner surface of the front plate 112.

The back electrode plate 231, made of metal material, has one surface in contact with the conductive washer 39 and the other surface with which an electret dielectric film (not shown) is coated. That is, a surface of the back electrode plate 231 that faces the diaphragm 161 is coated with the electret dielectric film. The other surface of the back electrode plate 231 makes contact with the insulating spacer 15.

The diaphragm 161 is attached to a surface of the diaphragm ring 16 that faces the back electrode plate 231.

The insulating spacer 15 is present between the back electrode plate 231 and the diaphragm 161 and keeps the space between the back electrode plate 231 and the diaphragm 161.

The conductive washer 39, the back electrode plate 231, the insulating spacer 15, the diaphragm ring 16, the gate ring 232, and the FPC board 12 are laminated and housed in the capsule 11. An edge on the open side of the capsule 11 is bent inward to fit against the flange 122 of the FPC board 12.

<Circuit Diagram>

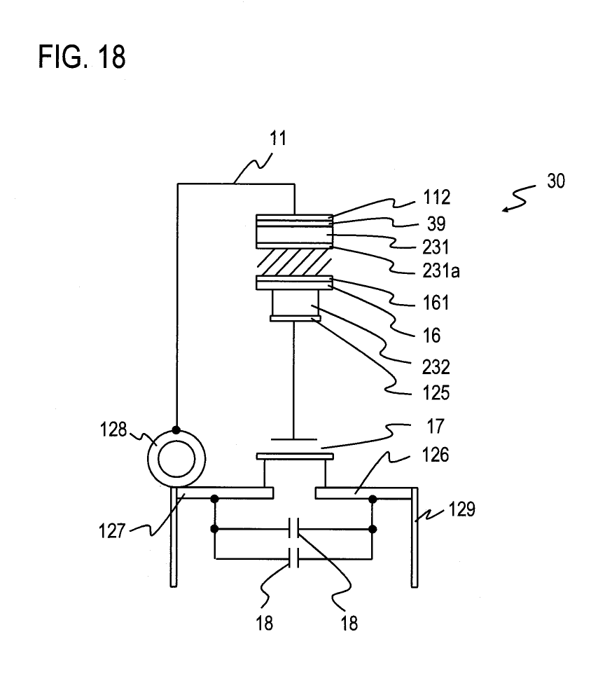

FIG. 18 shows a circuit diagram of the ECM 30. Since the edge 114 on the open side of the capsule 11 is bent inward to fit against a common electrode 128 on the flange 122, an electret dielectric film 231a is electrically connected to the common electrode 128 through the capsule 11, the front plate 112, the conductive washer 39, and the back electrode plate 231, and the diaphragm 161 is electrically connected to a gate electrode of the FET 17 through the diaphragm ring 16, the gate ring 232, and the gate pattern 125.

As is clear from the electric circuit shown in FIG. 18, the diaphragm 161 is vibrated by a sound and static electricity charged on the electret dielectric film 131a generates an electric signal on the diaphragm 161. This electric signal is subjected to impedance conversion by the FET 17 and output externally through the common electrode 128 and the signal electrode 129.

The reverse electret condenser microphone with such a structure has the same effects as the second embodiment.

<Other Modifications>

The present invention is not limited to the above embodiments and modifications. Various modifications may be made without departing from the spirit and scope of the invention.

What is claimed is:

1. An electret condenser microphone comprising:
a capsule that includes a first hollow cylinder and a front plate blocking one end face of the first hollow cylinder, the capsule being made of metal material;
a diaphragm ring that has one surface in contact with an inner surface of the front plate and the other surface to which a diaphragm is attached;
a back electrode plate that has a surface with which an electret dielectric film is coated, the surface facing the diaphragm, the back electrode plate being made of metal material;
an insulating spacer that is annularly formed and present between the back electrode plate and the diaphragm to keep a space between the back electrode plate and the diaphragm;
an impedance converter that performs impedance conversion of an electric signal generated on the back electrode plate and extracts a converted signal;
a flexible printed circuit board in which a second hollow cylinder, a flange that projects radially from an edge of the second hollow cylinder on one end face of the second hollow cylinder that faces the back electrode plate, and a rear plate that blocks the other end face of the second hollow cylinder are integrally formed, the impedance converter being placed on a surface of the rear plate that faces the back electrode plate; and
a gate ring that is cylindrically formed, is made of metal material, is present between the back electrode plate and the flexible printed circuit board to keep a space for housing the impedance converter between the back electrode plate and the flexible printed circuit board, and electrically connects the back electrode plate to wiring on the flexible printed circuit board;
wherein the diaphragm ring, the insulating spacer, the back electrode plate, the gate ring, and the flexible printed circuit board are laminated and housed in the capsule and an edge on an open side of the capsule is bent inward to fit against the flange of the flexible printed circuit board.

2. An electret condenser microphone comprising:
a capsule that includes a first hollow cylinder and a front plate blocking one end face of the first hollow cylinder, the capsule being made of metal material, an inner surface of the front plate being coated with an electret dielectric film;
a diaphragm ring that has a surface to which a diaphragm is attached, the surface facing a inner surface of the front plate;
an insulating spacer that is present between the inner surface of the front plate and the diaphragm to keep a space between the inner surface of the front plate and the diaphragm, the insulating spacer being annularly formed;
an impedance converter that performs impedance conversion of an electric signal generated on the diaphragm and extracts a converted signal;
a flexible printed circuit board in which a second hollow cylinder, a flange that projects radially from an edge of the second hollow cylinder on one end face of the second hollow cylinder that faces the inner surface of the front plate, and a rear plate that blocks the other end face of the second hollow cylinder are integrally formed, the impedance converter being placed on a surface of the rear plate that faces the diaphragm; and
a gate ring that is cylindrically formed, is made of metal material, is present between the diaphragm and the flexible printed circuit board to keep a space for housing the impedance converter between the diaphragm and the flexible printed circuit board, and electrically connects the diaphragm to wiring on the flexible printed circuit board;
wherein the insulating spacer, the diaphragm ring, the gate ring, and the flexible printed circuit board are laminated and housed in the capsule and an edge on an open side of the capsule is bent inward to fit against the flange of the flexible printed circuit board.

3. An electret condenser microphone comprising:
a capsule that includes a first hollow cylinder and a front plate blocking one end face of the first hollow cylinder, the capsule being made of metal material;
a conductive washer that has one surface in contact with an inner surface of the front plate, the conductive washer being annularly formed;
a back electrode plate that has one surface in contact with the conductive washer and the other surface with which an electret dielectric film is coated, the back electrode plate being made of metal material;
a diaphragm ring that has a surface to which a diaphragm is attached, the surface facing the back electrode plate;
an insulating spacer that is present between the back electrode plate and the diaphragm to keep a space between the back electrode plate and the diaphragm, the insulating spacer being annularly formed;
an impedance converter that performs impedance conversion of an electric signal generated on the diaphragm and extracts a converted signal;
a flexible printed circuit board in which a second hollow cylinder, a flange that projects radially from an edge of the second hollow cylinder on one end face of the second hollow cylinder that faces a inner surface of the front plate, and a rear plate that blocks the other end face of the second hollow cylinder are integrally formed, the impedance converter being placed on a surface of the rear plate that faces the diaphragm; and
a gate ring that is cylindrically formed, is made of metal material, is present between the diaphragm and the flexible printed circuit board to keep a space for housing the impedance converter between the diaphragm and the flexible printed circuit board, and electrically connects the diaphragm to wiring on the flexible printed circuit board;
wherein the conductive washer, the back electrode plate, the insulating spacer, the diaphragm ring, the gate ring, and the flexible printed circuit board are laminated and housed in the capsule and an edge on an open side of the capsule is bent inward to fit against the flange of the flexible printed circuit board.
